(19) United States
(12) Patent Application Publication
(10) Pub. No.: US 2009/0185307 A1
(43) Pub. Date: Jul. 23, 2009

(54) Fly height detection during write operation

(75) Inventor: Maxim Roth, Cupertino, CA (US)

Correspondence Address: IRELL & MANELLA LLP, 840 NEWPORT CENTER DRIVE, SUITE 400, NEWPORT BEACH, CA, 92660, US

(73) Assignee: Samsung Electronics Co., Ltd., Suwon City (KR)

(21) Appl. No.: 12/009,853

(22) Filed: Jan. 22, 2008

(51) Int. Cl. G11B 5/596

(52) U.S. Cl. 360/77.05

(57) ABSTRACT

A hard disk drive that includes a head that is coupled to a disk. The head has a flying height and an inductance. The disk drive also includes a circuit that detects a change in the flying height by sensing a change of head inductance. The circuit can inhibit a write operation if the change in inductance exceeds a threshold.

### BACKGROUND OF THE INVENTION

1. Field of the Invention

The present invention relates to detecting a change in a flying height of a head in a hard disk drive.

2. Background Information

Hard disk drives contain a plurality of magnetic heads that are coupled to rotating disks. The heads write and read information by magnetizing and sensing the magnetic fields of the disk surfaces. Each head is attached to a flexure arm to create a subassembly commonly referred to as a head gimbal assembly (“HGA”). The HGA's are suspended from an actuator arm. The actuator arm has a voice coil motor that can move the heads across the surfaces of the disks.

HGA transducers include three primary elements: a reader sensor, a writer structure and a head protrusion control element, also known as fly-on-demand (“FOD”). The reader sensor is commonly made of a spinning tunneling MR structure. The writer structure includes coils and a magnetic flux path structure made with high permeability and high magnetization material. The head protrusion control element (FOD device) is typically constructed of a heater coil. When a current is applied, the coil generates heat and causes the writer and reader elements to move closer to the media. The FOD device is used to dynamically set writer spacing and reader spacing to the disk surface during the operation of the disk drive.

During operation, each head is separated from a corresponding disk surface by an air bearing. The air bearing eliminates mechanical interference between the head and the disks. The FOD device is used to further set reader and writer positions above the disk surface, based on a pre-calibrated target. The strength of the magnetic field from the disk is inversely proportional to the height of the reader head spacing to the disk. Reduced spacing results in a stronger magnetic field on the disk, and vice versa.

The flying height of head may vary during the operation of the drive. For example, a shock load on the drive may create a vibration that causes the heads to mechanically resonate. The vibration causes the heads to move toward and then away from the disk surfaces in an oscillating manner. Particles or scratch ridges in the disk may also cause oscillating movement of the heads. The oscillating movement may occur in either a vertical or in-plane direction relative to the flexure arm.

If oscillation of the heads occurs during a write routine of the drive, the resultant magnetic field on the disk will vary inversely relative to the flying height. The varying magnetic field strength may result in poor writing of data. Errors may occur when the signal is read back by the drive. The errors can be detected by reading back the data in a write verify routine. Write verify routines reduce the access time and speed of the drive. Some high performance drives do not employ write verify routines. It would be desirable to detect undesirable flying heights in real time to prevent errors in writing data.

### BRIEF SUMMARY OF THE INVENTION

A hard disk drive that includes a head that is coupled to a disk. The head has a flying height and an inductance. The disk drive also includes a circuit that detects a change in the flying height by sensing a change of head inductance.

### BRIEF DESCRIPTION OF THE DRAWINGS

FIG. 1 is a top view of an embodiment of a hard disk drive;

FIG. 2 is an illustration of a head of the disk drive;

FIG. 3 is a schematic of an electrical circuit for the hard disk drive;

FIG. 4 is an illustration showing the reluctances of a head;

FIG. 5 is a schematic of a circuit that detects a change in flying height from a change in head inductance;

FIG. 6 is a graph showing the voltage across a write coil.

### DETAILED DESCRIPTION

Disclosed is a hard disk drive that includes a head that is coupled to a disk. The head has a flying height and an inductance. The disk drive also includes a circuit that detects a change in the flying height by sensing a change of head inductance. The circuit can inhibit a write operation if the change in inductance exceeds a threshold.

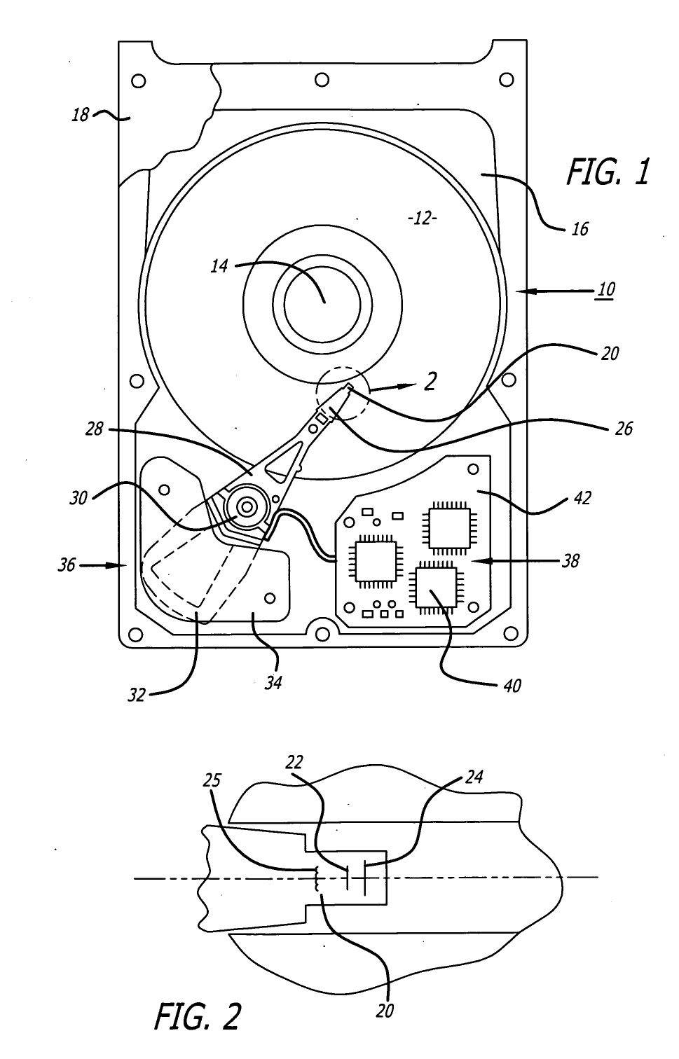

Referring to the drawings more particularly by reference numbers, FIG. 1 shows an embodiment of a hard disk drive 10. The disk drive 10 may include one or more magnetic disks 12 that are rotated by a spindle motor 14. The spindle motor 14 may be mounted to a base plate 16. The disk drive 10 may further have a cover 18 that encloses the disks 12.

The disk drive 10 may include a plurality of heads 20 located adjacent to the disks 12. As shown in FIG. 2 the heads 20 may have separate write 22 and read elements 24. The write element 22 magnetizes the disk 12 to write data. The read element 24 senses the magnetic fields of the disks 12 to read data. By way of example, the read element 24 may be constructed from a magneto-resistive material that has a resistance which varies linearly with changes in magnetic flux. Each head may include a heater element 25. A current can be provided to the heater elements to expand the heads and vary the head flying height. These types of heads are commonly referred to as fly-on-demand (“FOD”) heads.

Referring to FIG. 1, each head 20 may be gimbal mounted to a flexure arm 26 as part of a head gimbal assembly (HGA). The flexure arms 26 are attached to an actuator arm 28 that is pivotally mounted to the base plate 16 by a bearing assembly 30. A voice coil 32 is attached to the actuator arm 28. The voice coil 32 is coupled to a magnet assembly 34 to create a voice coil motor (VCM) 36. Providing a current to the voice coil 32 will create a torque that swings the actuator arm 28 and moves the heads 20 across the disks 12.

The hard disk drive 10 may include a printed circuit board assembly 38 that includes a plurality of integrated circuits 40 coupled to a printed circuit board 42. The printed circuit board 40 is coupled to the voice coil 32, heads 20 and spindle motor 14 by wires (not shown).

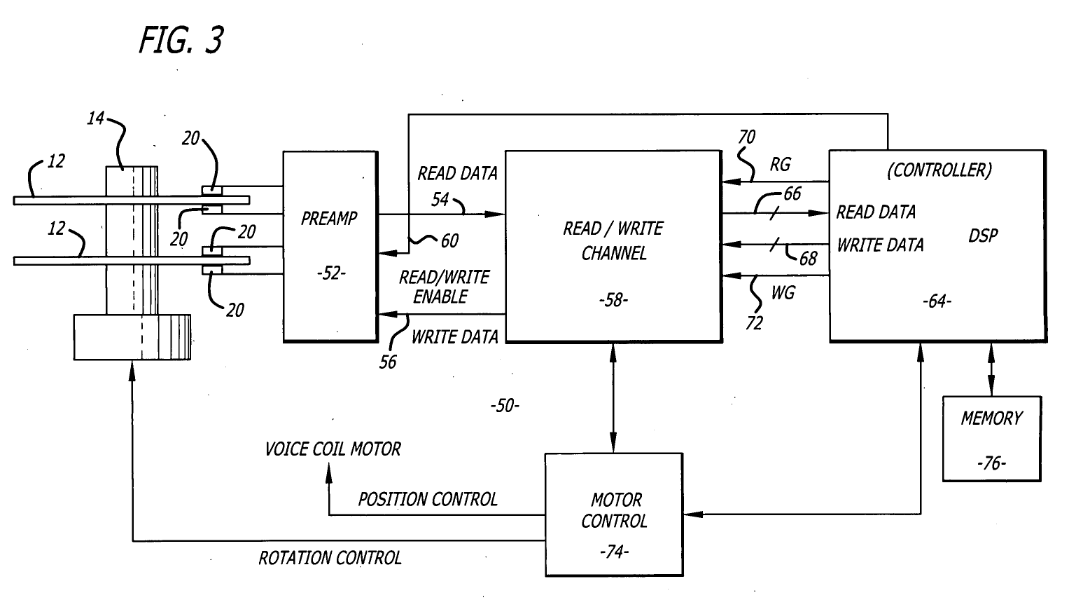

FIG. 3 shows an embodiment of an electrical circuit 50 for reading and writing data onto the disks 12. The circuit 50 may include a pre-amplifier circuit 52 that is coupled to the heads 20. The pre-amplifier circuit 52 has a read data channel 54 and a write data channel 56 that are connected to a read/write channel circuit 58. The pre-amplifier 52 also has a read/write enable gate 60 connected to a controller 64. Data can be written onto the disks 12, or read from the disks 12 by enabling the read/write enable gate 60.

The read/write channel circuit 58 is connected to a controller 64 through read and write channels 66 and 68, respectively, and read and write gates 70 and 72, respectively. The read gate 70 is enabled when data is to be read from the disks 12. The write gate 72 is to be enabled when writing data to the disks 12. The controller 64 may be a digital signal processor that operates in accordance with a software routine, including a routine(s) to write and read data from the disks 12. The read/write channel circuit 58 and controller 64 may also be connected to a motor control circuit 74 which controls the voice coil motor 36 and spindle motor 14 of the disk drive 10. The controller 64 may be connected to a non-volatile memory device 76. By way of example, the device 76 may be a read only memory (“ROM”) that contains instructions that are read by the controller 64.

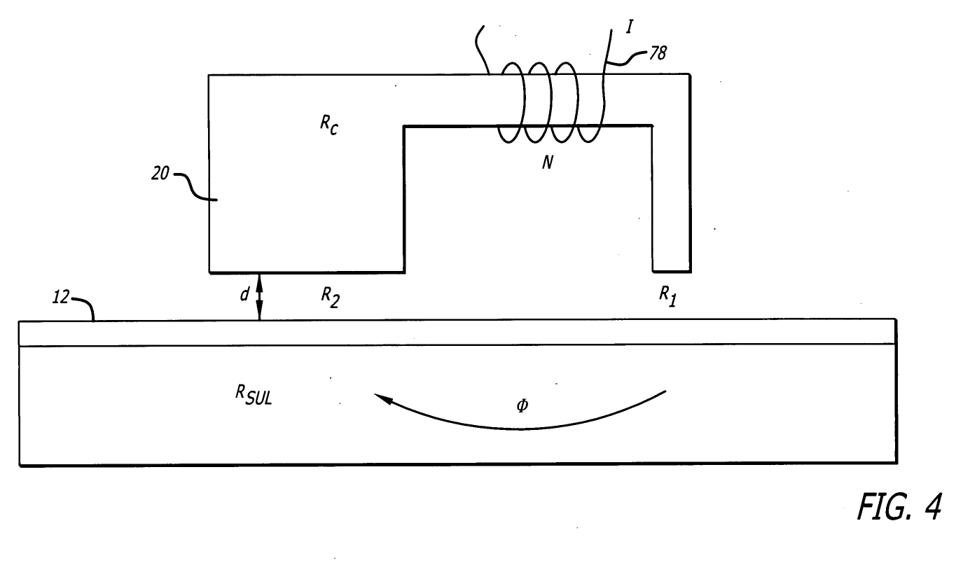

FIG. 4 shows an illustration of a head 20 adjacent to a disk 12. The head 20 includes a write coil 78 that forms part of the head write element. As is known in the art, when a current is provided to the write coil, the coil will emanate a magnetic flux. The head has a inductance defined by the equation:

$$L = N \frac{d φ}{d I} \qquad ( 1 )$$

The flux is defined by the equation:

$$φ = \frac{N \cdot I}{+ +} \qquad ( 2 )$$

where; [symbol]
=the pole reluctance defined by the equation

$$= \frac{d}{{μ}_{0} \cdot {A}_{pole}} \qquad$$

[symbol]

=the return reluctance defined by the equation

$$= \frac{d}{{μ}_{0} \cdot {A}_{return}}$$

[symbol]

=the reluctance of the head.
Substituting equation (2) into equation (1) results in the following equation:

$$L = \frac{{N}^{1}}{+ +} \qquad ( 3 )$$

For most heads Aᵣₑₜᵤᵣₙ>>Aₚₒₗₑ so that [symbol] << [symbol] . [symbol] is << [symbol] so that equation (2) can be rewritten as:

$$L ≅ \frac{{N}^{2} \cdot {μ}_{0} \cdot {A}_{pole}}{d} \qquad ( 4 )$$

From this equation it can be seen that the flying height d is inversely linearly proportional to the inductance of the head.

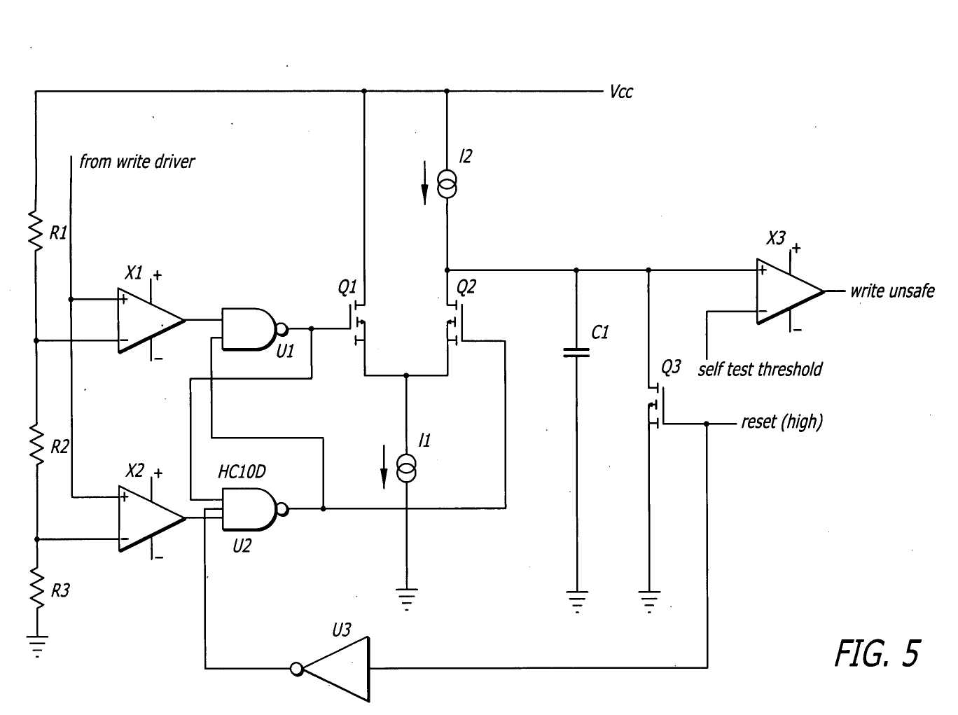

FIG. 5 is an embodiment of a circuit 100 that can detect a change in flying height by detecting a change in the head inductance. The circuit 100 can output a “write unsafe” signal that ceases operation of a write operation and causes a rewrite. The circuit 100 includes a pair of comparators X1 and X2 with negative terminals connected to a power line Vcc and resistors R1, R2 and R3. The positive terminals of the comparators are connected to an h-bridge terminal of the write coil (not shown). The outputs of the comparators X1 and X2 are connected to NAND gates U1 and U2, respectively. The NAND gates are cross-connected as shown in FIG. 4. The NAND gates U1 and U1 are connected to transistors Q1 and Q2. The source of the transistor Q2 is connected to the positive terminal of a comparator X3. The negative terminal of the comparator X3 is also connected to capacitor C1 and transistor Q3. The input of Q3 receives a RESET signal that is also provided to NAND gate U2 through diode U3.

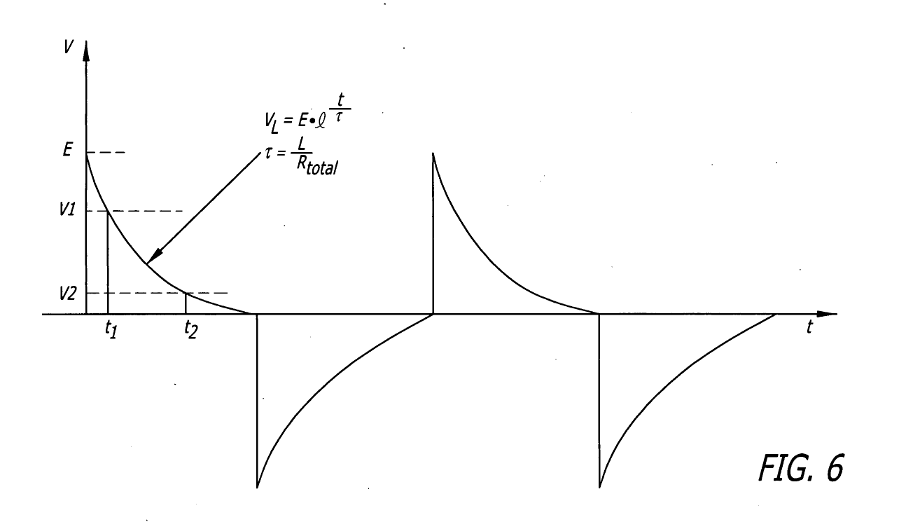

The operation of circuit 100 will discussed with reference to FIG. 6 which shows the voltage across the write coil. Voltage V1 corresponds to the voltage at the negative terminal of comparator X1. Rₜₒₜₐₗ is the total resistance in series with the coil. Voltage V2 corresponds to the voltage at the negative terminal of comparator X2. A change in inductance can be computed by measuring the time required to decay from V1 to V2.

In operation, the RESET signal is provided to turn on transistor Q3 and provide a positive input that causes NAND gate U2 to have a high output and NAND gate U1 to have a low output. This causes transistors Q1 and Q2 to turn off and on, respectively. When Q2 is on the current I2 flows to drain and the capacitor C1 discharges through transistor Q3.

Referring to FIG. 6, when the write coil voltage falls to V1 the comparator X1 will switch from high to low, such that the output of NAND gate U1 switches to high to cause transistor Q1 to turn on. The high output from NAND gate U1 causes NAND gate U2 to generate a low output to turn transistor Q2 off. The current I2 then charges capacitor C1. When the write coil voltage falls below V2 the comparator X2 switches low, which causes transistor Q1 to turn off and transistor Q2 to turn on, wherein the capacitor C1 no longer charges. If the capacitor C1 is fully charged before comparator X2 is switched low the comparator X3 will output the write unsafe signal to terminate writing.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A hard disk drive, comprising:
a disk;
a spindle motor that rotates said disk;
a head that is coupled to said disk and has a flying height and an inductance; and,
a circuit that detects a change in the flying height by sensing a change of said head inductance.

2. The disk drive of claim 1, wherein said circuit inhibits a write operation if said change in inductance exceeds a threshold.

3. The disk drive of claim 1, wherein said circuit senses a time rate of change of said inductance of said head.

4. The disk drive of claim 1, wherein said head includes a write coil and said circuit is coupled to said write coil.

5. A hard disk drive, comprising:
a disk;
a spindle motor that rotates said disk;
a head that is coupled to said disk and has a flying height and an inductance; and,
circuit means for detecting a change in the flying height by sensing a change of head inductance.

6. The disk drive of claim 5, wherein said circuit means inhibits a write operation if said change in inductance exceeds a threshold.

7. The disk drive of claim 5, wherein said circuit means senses a time rate of change of said inductance of said head.

8. The disk drive of claim 5, wherein said head includes a write coil and said circuit means is coupled to said write coil.

9. A method for detecting a change in a flying height of a head in a hard disk drive, comprising:
sensing a change in an inductance of a head to detect a change in a flying height of the head.

10. The method of claim 9, further comprising inhibiting a write operation if the change of the inductance of the head exceeds a threshold.

11. The method of claim 9, wherein a time rate of change of the inductance of the head is detected to detect a change in the flying height of the head.
